(19) United States
(12) Patent Application Publication
(10) Pub. No.: US 2022/0277592 A1
(43) Pub. Date: Sep. 1, 2022

(54) ACTION RECOGNITION DEVICE, ACTION RECOGNITION METHOD, AND ACTION RECOGNITION PROGRAM

(71) Applicant: NIPPON TELEGRAPH AND TELEPHONE CORPORATION, Tokyo (JP)

(72) Inventors: Takashi HOSONO, Tokyo (JP); Yongqing SUN, Tokyo (JP); Jun SHIMAMURA, Tokyo (JP); Atsushi SAGATA, Tokyo (JP); Kiyohito SAWADA, Tokyo (JP)

(73) Assignee: NIPPON TELEGRAPH AND TELEPHONE CORPORATION, Tokyo (JP)

(21) Appl. No.: 17/626,073

(22) PCT Filed: Jul. 10, 2020
(86) PCT No.: PCT/JP2020/027113

§ 371 Date: Jan. 10, 2022

(30) Foreign Application Priority Data
Jul. 12, 2019 (JP) 2019-130055

(51) Int. Cl. G06V 40/20; G06V 10/774; G06T 3/60; G06T 7/20; G06V 10/22; G06T 7/38

(52) U.S. Cl. CPC G06V 40/20; G06V 10/774; G06T 3/60; G06T 7/20; G06V 10/22; G06T 7/38; G06T 2207/10016; G06T 2207/20081

(57) ABSTRACT

An object is to accurately recognize an action of a subject. A direction alignment unit 24 is configured to perform at least one of rotation and inversion on an image based on an action direction of a desired subject in the image, so as to obtain an adjusted image. An action recognition device 26 is configured to recognize an action of the desired subject using the adjusted image as an input.

### TECHNICAL FIELD

The technology of the present disclosure relates to an action recognition device, an action recognition method, and an action recognition program.

### BACKGROUND ART

Action recognition techniques for recognizing by machine how a person in an input video is acting have wide-range industrial applications such as analyzing surveillance camera videos or sports videos, and human action comprehension of robots.

A highly accurate example of well-known techniques uses deep learning such as Convolutional Neural Network (CNN) and realizes high recognition accuracy (see FIG. 13). In NPL 1 for example, first, frame image groups and optical flow groups that are movement features corresponding to them are extracted from an input video. Then, 3D-CNN, which is convolution operation using spatial filtering, is used for the extracted groups, to train an action recognizer and perform action recognition.

### CITATION LIST

### Non Patent Literature

[NPL 1] J. Carreira and A. Zisserman, “Quo vadis, action recognition? a new model and the kinetics dataset,” in Proc. on Int. Conf. on Computer Vision and Pattern Recognition, 2018.

### SUMMARY OF THE INVENTION

### Technical Problem

However, to realize high performance in a method using CNN as disclosed in NPL 1, large amounts of training data are typically needed. One of the reasons therefore is considered to be that, as shown in FIG. 14, even one type of action has various apparent patterns on a video. For example, even a limited action of “turning right by car” has numerous apparent patterns due to diversity of action directions such as turning right from a lower side on the video, and turning downward from the left. To construct an action recognizer that is robust against such various apparent patterns, it is conceivable that well-known techniques require large amounts of training data.

Meanwhile, when constructing training data for action recognition, it is required to add the types of actions, occurrence time, and locations to videos, which incurs a high human cost for this operation, and thus it is not easy to prepare sufficient amount of training data. Also, if there are small amounts of training data open to the public such as surveillance camera videos, application of such published data cannot be expected. There is the problem that although, as described above, large amounts of training data including various apparent patterns are required to realize accurate action recognition, but it is not easy to construct such training data.

The disclosed technique was made in view of the aforementioned circumstances, and an object thereof is to provide an action recognition device, an action recognition method, and an action recognition program that can accurately recognize an action of a subject.

### Means for Solving the Problem

According to a first aspect of the present disclosure, an action recognition device for recognizing, upon input of an image in which a desired subject is captured, an action of the desired subject includes: a direction alignment unit configured to perform at least one of rotation and inversion on the image based on an action direction of the desired subject in the image or an action direction of a subject other than the desired subject, so as to obtain an adjusted image; and an action recognition unit configured to recognize an action of the desired subject using the adjusted image as an input.

According to a second aspect of the present disclosure, an action recognition method for recognizing, upon input of an image in which a desired subject is captured, an action of the desired subject includes the steps of: a direction alignment unit performing at least one of rotation and inversion on the image based on an action direction of the desired subject in the image or an action direction of a subject other than the desired subject, so as to obtain an adjusted image; and an action recognition unit recognizing an action of the desired subject using the adjusted image as an input.

According to a third aspect of the present disclosure, an action recognition program for recognizing, upon input of an image in which a desired subject is captured, an action of the desired subject is for causing a computer to execute the steps of: performing at least one of rotation and inversion on the image based on an action direction of the desired subject in the image or an action direction of a subject other than the desired subject, so as to obtain an adjusted image; and recognizing an action of the desired subject using the adjusted image as an input.

### Effects of the Invention

According to the disclosed technique, it is possible to accurately recognize an action of a subject.

### BRIEF DESCRIPTION OF DRAWINGS

FIG. 1 is a diagram illustrating an overview of action recognition and learning processing according to the present embodiment.

FIG. 2 is a schematic block diagram illustrating an example of a computer that functions as a learning device and an action recognition device according to a first embodiment and a second embodiment.

FIG. 3 is a block diagram illustrating a configuration of the learning device according to the first embodiment and the second embodiment.

FIG. 4 is a diagram illustrating a method for aligning action directions.

FIG. 5 is a block diagram illustrating a configuration of the action recognition device according to the first embodiment and the second embodiment.

FIG. 6 is a flowchart illustrating a learning processing routine of the learning device according to the first embodiment and the second embodiment.

FIG. 7 is a flowchart illustrating an action recognition processing routine of the action recognition device according to the first embodiment and the second embodiment.

FIG. 8 is a diagram illustrating a method for aligning action directions.

FIG. 9 is a diagram illustrating an overview of action recognition processing according to an experimental example.

FIG. 10 is a diagram illustrating recognition results in the experimental example.

FIG. 11 illustrates images and optical flows before action directions are aligned in the experimental example.

FIG. 12 illustrates images and optical flows after the action directions were aligned in the experimental example.

FIG. 13 is a diagram illustrating an example of conventional action recognition.

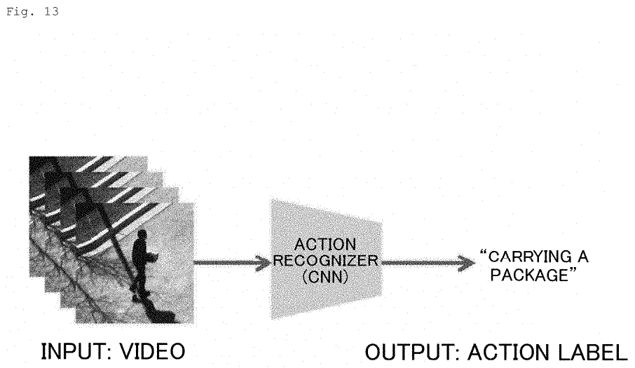

FIG. 14 illustrates examples of action directions of input images.

### DESCRIPTION OF EMBODIMENTS

Hereinafter, examples of embodiments according to the disclosed technique will be described with reference to the drawings. Note that, in the drawings, the same reference numerals are given to the same or equivalent constituent components and portions. Also, the scale of the drawings is exaggerated for illustrative reasons, and may be different from the actual scale.

### Overview of the Present Embodiment

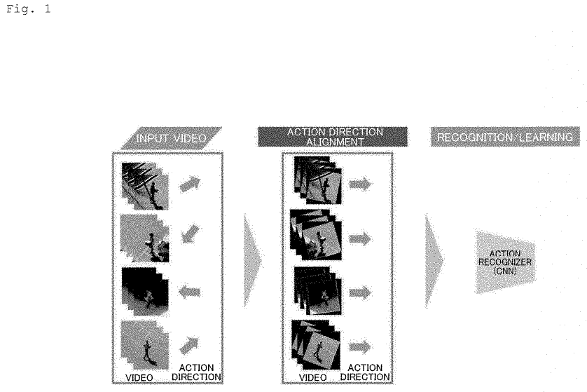

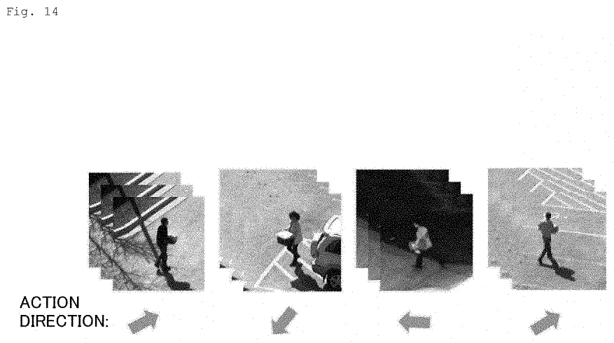

In the present embodiment, a means for aligning action directions with one direction is provided in order to suppress the influence of the diversity of apparent patterns. Specifically, with respect to a person in a video or an object operated by a person, a direction (action direction) of its movement on an image is calculated based on the previous and next frame images thereof. Then, the image for use in learning and recognition is rotated so that the action direction is aligned with a predetermined reference direction (for example, to right from left). For learning and recognition, not only frame images but also optical flow images, which express an inter-image movement as images, may be used (see FIG. 1). That is to say, the present embodiment is to improve the estimation accuracy by reducing the diversity of data to be learned by one neural network. For example, in the case of FIG. 14, persons are carrying a package toward various directions from the corresponding reference images. If such image groups are directly used for training, a learning device needs to be trained to estimate that the persons are carrying the package regardless of which direction they are moving. That is to say, if there is no sufficient number of learning images for each direction, learning does not converge sufficiently, and as a result, the model may have a low accuracy. In the present embodiment, by rotating and/or inverting learning images and generating groups of learning images oriented in “a certain direction”, it is possible to generate sufficient number of learning images, while reducing the diversity of data to be learned by a neural network.

At this time, if an action label indicates an action (for example, turning right or left) including a temporal change in the action direction, there is a risk that rotating frame images one by one may lose the features of this action (for example, turning right or left may be recognized as traveling straight). In such a case, it is considered to be preferable to uniformly rotate the entire video, instead of to rotate each frame image of the video.

Therefore, the following embodiments, descriptions will be given separately for an embodiment in which each frame image is rotated, and an embodiment in which the entire video is rotated, depending on the action indicated by an action label. This is effective when the importance of a temporal change in an action direction depends on the type of an object operated by a person. For example, in analysis of surveillance camera videos, in order to monitor illegal acts, actions that do not include any temporal change in an action direction, such as “carrying an object” and “loading and unloading a package”, often need to be recognized as action labels indicating actions of persons. On the other hand, for action labels indicating actions of cars, actions that include a temporal change in an action direction such as “turning right or left” often need to be recognized.

Note that in the embodiments, an action is a concept that encompasses both an act of a single movement, and an activity including a plurality of movements.

### First Embodiment

<Configuration of Learning Device According to First Embodiment>

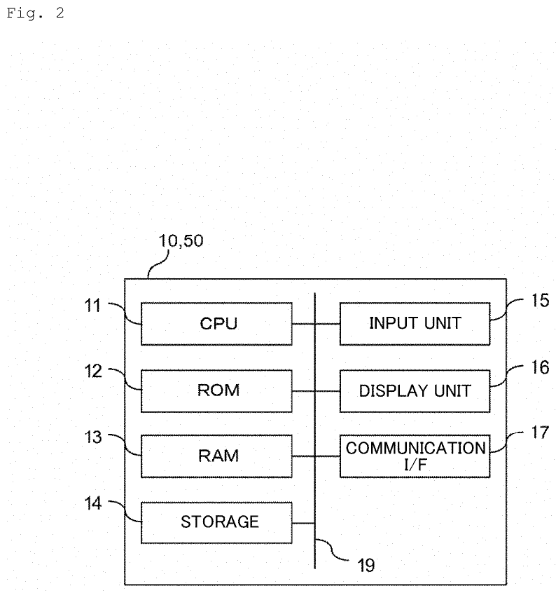

FIG. 2 is a block diagram illustrating a hardware configuration of a learning device 10 according to the present embodiment.

As shown in FIG. 2, the learning device 10 includes a CPU (Central Processing Unit) 11, a ROM (Read Only Memory) 12, a RAM (Random Access Memory) 13, a storage 14, an input unit 15, a display unit 16, and a communication interface (I/F) 17. These constituent components are connected via a bus 19 so as to communicate with each other.

The CPU 11 is a central processing unit, and is configured to execute various types of programs and control the components, for example. That is to say, the CPU 11 reads out a program from the ROM 12 or the storage 14, and executes the program using the RAM 13 as a work area. The CPU 11 executes control of the above-described constituent components and various types of arithmetic processing, in accordance with programs stored in the ROM 12 or the storage 14. In the present embodiment, a learning program for training a neural network is stored in the ROM 12 or the storage 14. A single learning program may be stored, or a program group constituted by a plurality of programs or modules may be stored.

The ROM 12 stores various types of programs and various types of data. The RAM 13, serving as a work area, temporarily stores a program or data. The storage 14 is constituted by an HDD (Hard Disk Drive) or an SSD (Solid State Drive), and stores various types of programs including an operating system, and various types of data.

The input unit 15 includes a pointing device such as a mouse, and a keyboard, and is used to create various types of inputs.

The input unit 15 accepts inputs of a set of video that is an image group constituted by a plurality of images in which a desired subject is captured in a time-series manner, and action label indicating the type of an action of the desired subject.

The display unit 16 is a liquid crystal display for example, and displays various types of information. The display unit 16 may employ a touch panel system, and may function as the input unit 15.

The communication interface 17 is an interface for communicating with another device, and employs a standard such as Ethernet (registered trademark), FDDI, or Wi-Fi (registered trademark), for example.

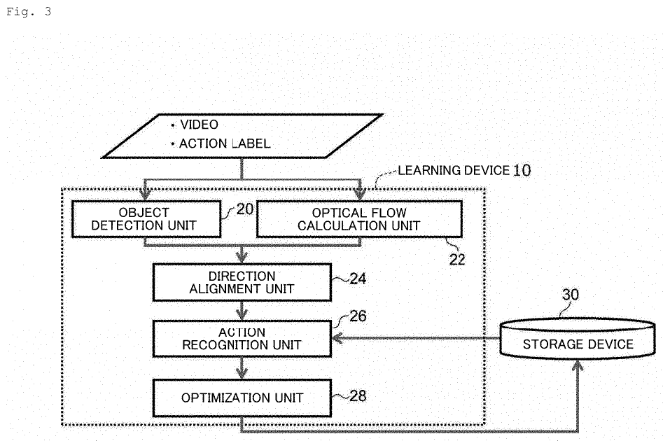

The following will describe a functional configuration of the learning device 10. FIG. 3 is a block diagram showing an example of the functional configuration of the learning device 10.

As shown in FIG. 3, the learning device 10 includes, as functional units, an object detection unit 20, an optical flow calculation unit 22, a direction alignment unit 24, an action recognition unit 26, and an optimization unit 28.

The object detection unit 20 estimates the type of the subject and an object region that represents this subject, for each of frame images of the input video.

The optical flow calculation unit 22 calculates an optical flow, which is a motion vector of pixels between the frame images. The processing of the object detection unit 20 and the processing of the optical flow calculation unit 22 may be executed in parallel to each other.

The direction alignment unit 24 estimates, for each of the frame images of the input video, the action direction in the object region based on the results of the object detection and the optical flow calculation. The direction alignment unit 24 performs at least one of rotation and inversion on the input video so that the action directions estimated for the frame images are aligned with a reference direction, thereby obtaining adjusted images.

The action recognition unit 26 recognizes the action label of the desired subject from the video that is constituted by the adjusted images and in which the action directions were aligned, based on a parameter of an action recognizer stored in a storage device 30.

The optimization unit 28 learns the parameter of the action recognizer, by associating each of the adjusted images with the action label, the adjusted images being obtained by performing at least one of rotation and inversion on the frame images in which the desired subject is captured so that the action directions of the desired subject are aligned with the reference direction. Specifically, the action label recognized from the video constituted by the adjusted images is compared with the input action label, and the parameter of the action recognizer is updated based on whether or not the recognition result is correct. Learning is performed by repeating this operation a certain number of times. The following will describe the components of the learning device 10 in detail.

The object detection unit 20 detects the type and position of a desired subject (for example, a person or an object operated by a person). Any promising method can be used as the object detection method. For example, an object detection method as disclosed by Reference Document 1 can be performed on each frame image to realize object detection. Also, by performing an object tracking method as disclosed in Reference Document 2 on an object detection result of the first frame, the type and position of an object from the second frames onwards may also be estimated.

[Reference Document 1] K. He, G. Gkioxari, P. Dollar and R. Grishick, “Mask R-CNN,” in Proc. IEEE Int Conf. on Computer Vision, 2017.

[Reference Document 2] A. Bewley, Z. Ge, L. Ott, F. Ramos, B. Uperoft, “Simple online and realtime tracking,” in Proc. IEEE Int. Conf. on Image Processing, 2017.

The optical flow calculation unit 22 calculates, based on pixels or feature points of each frame image, a motion vector of the object between adjacent frame images. Any promising method such as the method disclosed in Reference Document 3 can be used to calculate an optical flow.

[Reference Document 3] C. Zach, T. Pock, and H. Bischof, “A duality based approach for realtime TV-L1 optical flow,” Pattern Recognition, Vol. 4713, pp. 214-223, 2007. The Internet <URL: https://pequan.lip6.fr/˜bere ziat/cours/master/vision/papers/zach07.pdf>

The direction alignment unit 24 performs at least one of rotation and inversion on the video so that action directions of the desired subject are aligned with the reference direction, based on the object detection result and the optical flow calculation result, thereby obtaining adjusted images.

To estimate the action direction of the subject in the video, first, a dominant movement direction of an object region that represents the desired subject in each frame image is calculated. Specifically, a movement direction histogram is generated based on the angles of the motion vectors of the optical flow that are included in the object region of each frame image, and the median thereof is defined as the action direction of this frame image. Here, a value Hⁱ(b) of each bin b of a movement direction histogram Hⁱ in the i-th frame is defined as the following expression.

$$\begin{matrix}[ Math 1 ] & \\ {H}^{i} ( b ) = {\sum }_{r ∈ q} Q ( {O}_{r}^{i} , b ) , b = 1 , … , B , & ( 1 )\end{matrix}$$

Where r denotes the position of a pixel included in an object region q (a person region or car region in the present embodiment) that represents a desired subject in the frame image, Oⁱᵣ denotes the angle of the motion vector at the position r in the optical flow image of the i-th frame, Q(Oⁱᵣ, b) is a function that takes 1 when the angle Oⁱᵣ belongs to the bin b, and otherwise 0, and B denotes the number of bins of the histogram. By defining the representative value (median, for example) of this histogram as the action direction, it is possible to estimate the action direction in a robust manner against noise such as a background or limb movement.

Then, each frame image is rotated based on the action direction just obtained, and an adjusted image is obtained. The following will describe a case where the action direction is aligned with a reference direction that is a rightward direction (0 degree). In this case, it is sufficient to rotate the image clockwise by the angle of the action direction. Here, if the top and bottom of the video are inverted (if the action direction is from 90° to 270° degrees in the case where it is aligned with 0° degree), the vision of the video will largely vary, which may adversely affect the action direction. Therefore, by inverting the values of the image and the action direction around a vertical axis in advance and then aligning the action direction, the inversion of the top and bottom is prevented. In other words, letting the action direction be θ, a rotation angle θ′ is given by the following expression.

$$\begin{matrix}[ Mat h 2 ] & \\ {θ}^{′} = \{ \begin{matrix}- θ if 0 \leq θ < 90 or 270 < θ \leq 360 \\ 180 - θ otherwis e\end{matrix} & ( 2 )\end{matrix}$$

Here, if the action direction θ is in a predetermined inversion angle range (greater than or equal to 0° and smaller than 90°, or greater than 270° and smaller than or equal to 360°), θ′ is a rotation angle of rotation that is to be performed after the inversion. Here, if an optical flow needs to be input to the action recognizer, the optical flow is also rotated.

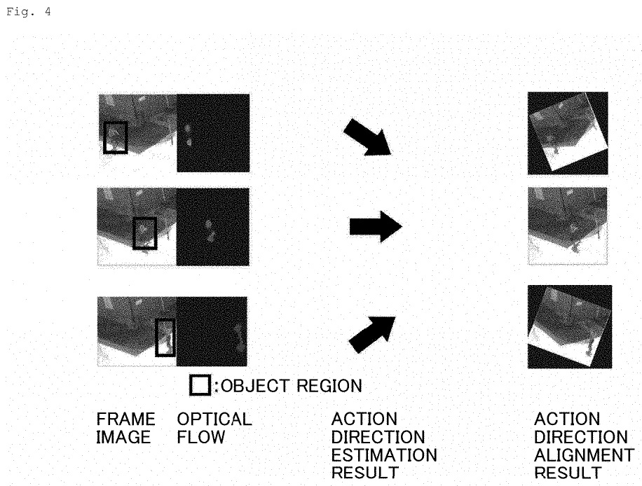

In the present embodiment, since an action that does not include any temporal change in the action direction is recognized as an action label indicating an action of the desired subject, the frame image of each frame is rotated or inverted, and an adjusted image is obtained (see FIG. 4). An action label in the present embodiment indicates an action that does not include any temporal change in the action direction, and examples thereof include “carrying a package”, “walking”, and “running”.

The action recognition unit 26 recognizes an action label that indicates an action of the subject in the video in which the action directions were aligned and that is constituted by the adjusted images, based on a model of the action recognizer and parameter information stored in the storage device 30. The action recognizer may be any promising recognizer such as one according to the method disclosed in NPL 1.

The optimization unit 28 optimizes the parameter of the action recognizer based on the input action label and the action label recognized by the action recognition unit 26, and stores the result thereof in the storage device 30, thereby training the action recognizer. Here, any promising algorithm such as one according to the method disclosed in NPL 1 can be used as the algorithm for optimizing the parameter.

<Configuration of Action Recognition Device According to First Embodiment>

FIG. 1 is a block diagram showing a hardware configuration of an action recognition device 50 according to the present embodiment.

As shown in FIG. 1, similar to the learning device 10, the action recognition device 50 includes a CPU (Central Processing Unit) 11, a ROM (Read Only Memory) 12, a RAM (Random Access Memory) 13, a storage 14, an input unit 15, a display unit 16, and a communication interface (I/F) 17. In the present embodiment, an action recognition program for executing action recognition on a video is stored in the ROM 12 or the storage 14.

The input unit 15 accepts an input of a video constituted by time-series images in which a desired subject is captured.

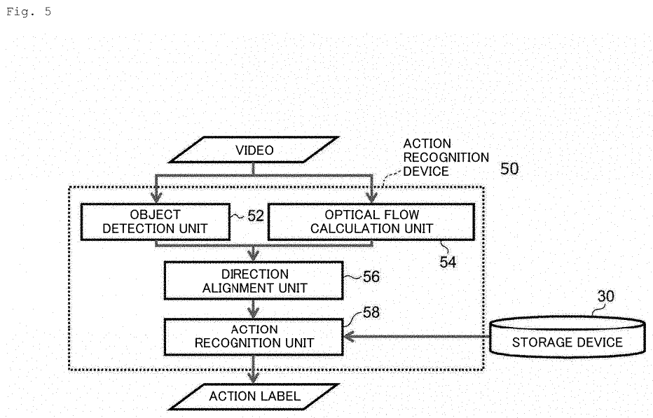

The following will describe a functional configuration of the action recognition device 50. FIG. 5 is a block diagram showing an example of the functional configuration of the action recognition device 50.

As shown in FIG. 5, the action recognition device 50 includes, as functional units, an object detection unit 52, an optical flow calculation unit 54, a direction alignment unit 56, and an action recognition unit 58.

Similar to the object detection unit 20, the object detection unit 52 estimates the type of the subject and an object region that represents this subject, for each of frame images of the input video.

Similar to the optical flow calculation unit 22, the optical flow calculation unit 54 calculates an optical flow, which is a motion vector of pixels between the frame images. The processing of the object detection unit 52 and the processing of the optical flow calculation unit 54 may be executed in parallel to each other.

Similar to the direction alignment unit 24, the direction alignment unit 56 estimates the action directions of the subject based on the object detection result and the optical flow calculation result, and performs at least one of rotation and inversion on the input video so that the estimated action directions are aligned with a reference direction, thereby obtaining adjusted images.

The action recognition unit 58 recognizes the action label indicating an action of the subject from the video that is constituted by the adjusted images and in which the action directions were aligned, based on a parameter of the action recognizer stored in the storage device 30.

<Effects of Learning Device According to First Embodiment>

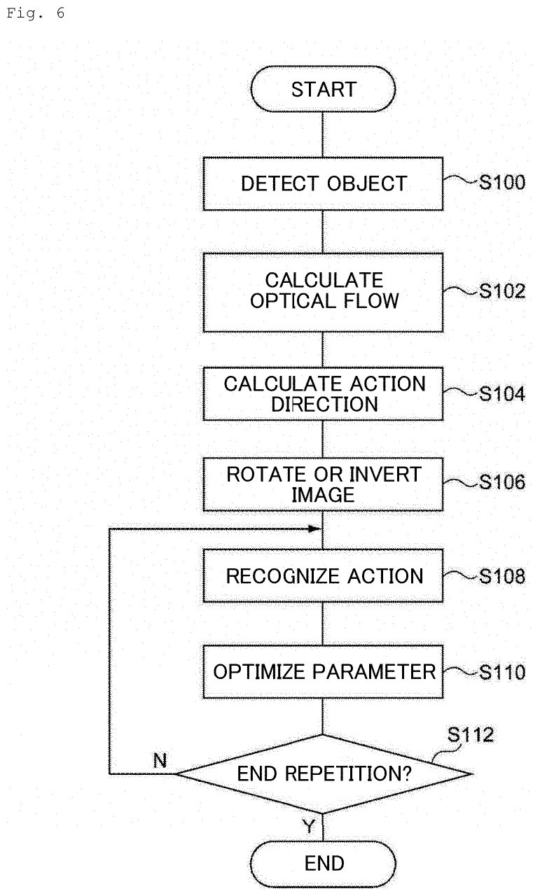

The following will describe effects of the learning device 10. FIG. 6 is a flowchart showing a flow of learning processing performed by the learning device 10. The learning processing is executed by the CPU 11 reading out the learning program from the ROM 12 or the storage 14, and expanding and executing the read learning program onto the RAM 13. Also, a plurality of sets of video in which a desired subject is captured and action label are input to the learning device 10.

In step S100, the CPU 11 serves as the object detection unit 20, and estimates the type of the subject and an object region that represents this subject, for each of frame images of each video.

In step S102, the CPU 11 serves as the optical flow calculation unit 22, and calculates, for each video, an optical flow, which is a motion vector of pixels between the frame images.

In step S104, the CPU 11 serves as the direction alignment unit 24, and estimates, for each video, the action direction of the subject in each of the frame images based on the result of the object detection in step S100 and the result of the optical flow calculation in step S102.

In step S106, the CPU 11 serves as the direction alignment unit 24, and performs, for each video, at least one of rotation and inversion on each of the frame images so that the action directions estimated for the frame images are aligned with a reference direction, thereby obtaining adjusted images.

In step S108, the CPU 11 serves as the action recognition unit 26, and recognizes, for each video, the action label from the video that is constituted by the adjusted images and in which the action directions were aligned, based on a parameter of the action recognizer stored in the storage device 30.

In step S110, the CPU 11 serves as the optimization unit 28, and compares, for each video, the recognized action label with the input action label, and updates the parameter of the action recognizer stored in the storage device 30 based on whether or not the recognition result is correct.

In step S112, the CPU 11 determines whether or not to end the repetition. If the repetition is to be ended, the learning processing is ended. On the other hand, if the repetition is not to be ended, the procedure returns to step S108.

<Effects of Action Recognition Device According to First Embodiment>

The following will describe effects of the action recognition device 50.

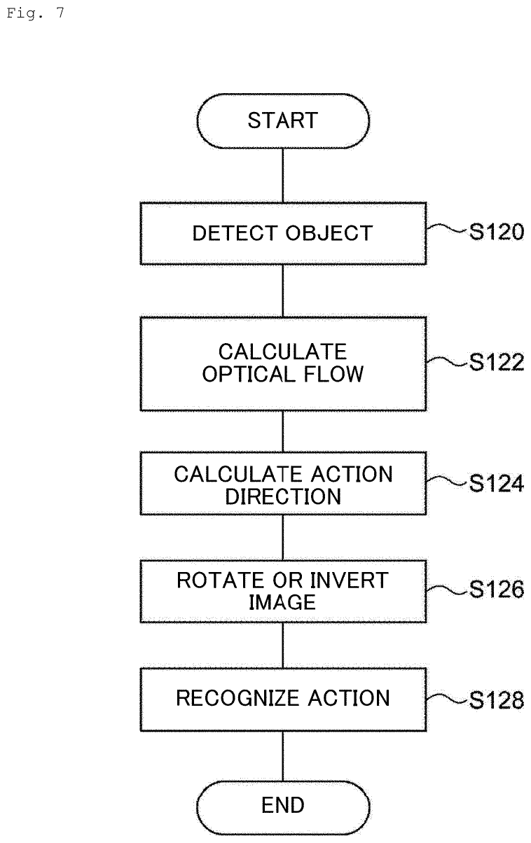

FIG. 7 is a flowchart showing a flow of action recognition processing performed by the action recognition device 50. The action recognition processing is performed by the CPU 11 reading out the action recognition program from the ROM 12 or the storage 14, and expanding and executing the read action recognition program on the RAM 13. Also, a video in which a desired subject is captured is input to the action recognition device 50.

In step S120, the CPU 11 serves as the object detection unit 52, and estimates the type of the subject and an object region that represents this subject, for each of frame images of the video.

In step S122, the CPU 11 serves as the optical flow calculation unit 54, and calculates an optical flow, which is a motion vector of pixels between the frame images.

In step S124, the CPU 11 serves as the direction alignment unit 56, and estimates the action direction of the subject in each frame image, based on the result of the object detection in step S120 and the result of the optical flow calculation in step S122.

In step S126, the CPU 11 serves as the direction alignment unit 56, and performs at least one of rotation and inversion on each of the frame images of the video so that the action directions estimated for the frame images are aligned with a reference direction, thereby obtaining adjusted images.

In step S128, the CPU 11 serves as the action recognition unit 58, and recognizes the action label from the video that is constituted by the adjusted images and in which the action directions were aligned, based on a parameter of the action recognizer stored in the storage device 30, displays the recognized action label on the display unit 16, and ends the action recognition processing.

As described above, upon input of an image in which a desired subject is captured, the action recognition device according to the first embodiment performs at least one of rotation and inversion on the image based on an action direction of the desired subject in the image, so as to obtain an adjusted image. The action recognition device recognizes an action of the desired subject using the adjusted image as an input. With this, it is possible to accurately recognize an action of a subject.

Also, the learning device according to the first embodiment can train an action recognizer that can perform accurate action recognition with small amount of training data, even if an action of the same label is an action having many mapping patterns on an image due to the diversity of the action directions.

Also, by aligning action directions of an input video so that the action directions are unified when learning and recognition are performed, it is possible to suppress an increase in apparent patterns generated due to the diversity of the action directions, and train an accurate action recognizer even with small amount of training data.

### Second Embodiment

The following will describe a learning device and an action recognition device according to a second embodiment. Note that the learning device and the action recognition device according to the second embodiment have the same configurations as those in the first embodiment, and thus the same reference numerals are given and descriptions thereof are omitted.

<Overview of Second Embodiment>

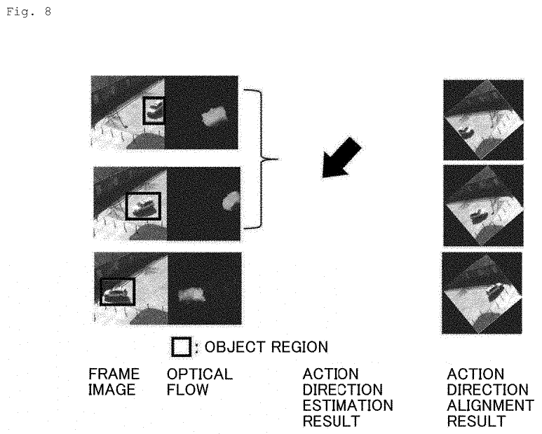

If an action label such as “turning right or left” indicates an action that includes any temporal change in the action direction, it is conceivable that rotating each frame image may reduce the accuracy of action recognition. Therefore, in the present embodiment, as shown in FIG. 8, it is considered to be preferable to calculate one action direction based on the entire video, and rotate all the frame images by the same rotation angle. Also, in view of the fact that the action direction largely changes in the video, it is considered to be preferable to estimate the action direction based on part of the video.

For example, the action direction is calculated based on the first half of the video. In this case, a value H(b) of each bin of a movement direction histogram H(b) in the entire video is calculated using the following expression.

$$\begin{matrix}[ Math 3 ] & \\ H ( b ) = {\sum }_{i}^{I / 2} {H}^{i} ( b ) , b = 1 , … , B , & ( 3 )\end{matrix}$$

Where I denotes the number of frames of the video. The median of this histogram is defined as the action direction of the entire video, and the frame images are rotated as in the first embodiment, thereby aligning the action directions.

<Configuration of Learning Device According to Second Embodiment>

As shown in FIG. 1, the hardware configuration of a learning device 10 according to the present embodiment is the same as that of the learning device 10 of the first embodiment.

The following will describe a functional configuration of the learning device 10.

The direction alignment unit 24 of the learning device 10 performs at least one of rotation and inversion on the video so that action directions of a desired subject are aligned with a reference direction, based on an object detection result and an optical flow calculation result, thereby obtaining adjusted images.

Specifically, to estimate the action direction of the subject in the video, first, a dominant movement direction of an object region in each frame image is calculated. For example, a movement direction histogram is generated based on the angles of the motion vectors of the optical flow that are included in the object region of each frame image, and the median thereof is defined as the action direction of this frame. Then, based on the value Hⁱ(b) of each bin (b) of the movement direction histogram Hⁱ in the i-th frame image that is included in the first half of the video, the value H(b) of each bin of the movement direction histogram of the entire video is calculated using the expression (3) above, and the median thereof is defined as the action direction of the entire video.

Also, in the present embodiment, since an action that includes a temporal change in the action direction is recognized as an action label indicating an action of a person, rotation or inversion is performed on the frame images of each video. Examples of an action label in the present embodiment include “moving forward”, “turning right”, “turning left”, “moving backward”, and “U-turning”.

As described above, the direction alignment unit 24 calculates one action direction from the entire video, and performs at least one of rotation and inversion on all of the frame images, so as to obtain adjusted images. Here, when rotation is performed on all the frame images, all the frame images are rotated by the same rotation angle, and when inversion is performed, all the frame images are inverted.

The action recognition unit 26 recognizes, from the video constituted by the adjusted images and the action directions were aligned, an action label that indicates an action of the subject in the video based on a model of an action recognizer and parameter information stored in a storage device 30. Here, if the video is inverted by the direction alignment unit 24, and the recognized action label indicates an action (such as turning right or left) whose action label is changed when the video is inverted, the action label will also be changed so as to correspond to the inverted video.

The optimization unit 28 optimizes the parameter of the action recognizer based on the input action label and the action label recognized by the action recognition unit 26, and stores the result thereof in the storage device 30, thereby training the action recognizer. Here, if the action label is changed by the action recognition unit 26 so as to correspond to the inverted video, the optimization unit 28 also changes the action label to one that corresponds to the inverted video.

Note that other configurations and effects of the learning device 10 are the same as those in the first embodiment, and thus descriptions thereof are omitted.

<Configuration of Action Recognition Device According to Second Embodiment>

As shown in FIG. 1, the hardware configuration of an action recognition device 50 according to the present embodiment is the same as that of the action recognition device 50 in the first embodiment.

The following will describe a functional configuration of the action recognition device 50.

Similar to the direction alignment unit 24, the direction alignment unit 56 of the action recognition device 50 estimates the action directions of a desired subject based on an object detection result and an optical flow calculation result, and performs at least one of rotation and inversion on an input video so that the estimated action directions are aligned with a reference direction, thereby obtaining adjusted images.

Here, the direction alignment unit 56 calculates one action direction from the entire video, and performs at least one of rotation and inversion on all the frame images, so as to obtain adjusted images. Here, when rotation is performed on all the frame images, all the frame images are rotated by the same rotation angle, and when inversion is performed, all the frame images are inverted.

The action recognition unit 58 recognizes the action label from the video that is constituted by the adjusted images and in which the action directions were aligned, based on a parameter of an action recognizer stored in the storage device 30.

Note that other configurations and effects of the action recognition device 50 are the same as those in the first embodiment, and thus descriptions thereof are omitted.

As described above, upon input of a video in which a desired subject is captured, the action recognition device according to the second embodiment performs at least one of rotation and inversion on the entire video based on the action direction of the desired subject in each of the frame images, so as to obtain adjusted images. The action recognition device recognizes an action of the desired subject using the video constituted by the adjusted images as an input. With this, it is possible to accurately recognize an action of the subject.

### EXPERIMENTAL EXAMPLE

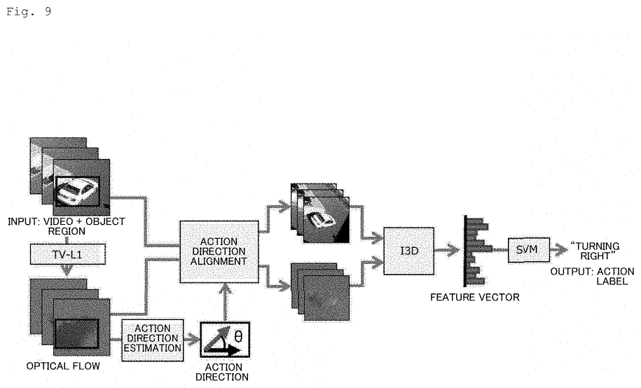

The following will describe an experimental example using the action recognition device described in the second embodiment. In the experimental example, as shown in FIG. 9, TV-LI algorithm (Reference Document ) was used for optical flow calculation. I3D (Reference Document 5) and SVM were used as action recognizers, and visible light images and optical flows were input.

[Reference Document 4] Zach, C., Pock, T. and Bischof, H.: A Duality Based Approach for Realtime TV-L1 Optical Flow, Pattern Recognition, Vol. 4713, pp. 214{223 (2007).

[Reference Document 5] Carreira, J. and Zisserman, A.: Quo Vadis, Action Recognition? A New Model and the Kinetics Dataset, IEEE Conf. on Computer Vision and Pattern Recognition (2017).

As network parameters of I3D, learned parameters of Kinetics Dataset (Reference Document 6) published by the authors of the document were used. Only SVM was trained, and an RBF kernel was used as an SVM kernel. An object region was given manually, and was assumed to have been estimated by object detection or the like.

[Reference Document 6] Kay, W., Carreira, J., Simonyan, K., Zhang, B., Hillier, C., Vijayanarasimhan, S., Viola, F., Green, T., Back, T., Natsev, P., Suleyman, M. and Zisserman, A.: The Kinetics Human Action Video Dataset, arXiv preprint arXiv:1705.06950 (2017).

The experiment was conducted only using, out of the ActEV data set (Reference Document 7), data (about 300 video) regarding turning right, turning left, and U-turning of cars.

[Reference Document 7] Awad, G., Butt, A., Curtis, K., Lee, Y., Fiscus, J., Godil, A., Joy, D., Delgado, A., Smeaton, A. F., Graham, Y., Kraaij, W., Qunot, G., Magalhaes, J., Semedo, D. and Blasi, S.: TRECVID 2018: Benchmarking Video Activity Detection, Video Captioning and Matching, Video Story-telling Linking and Video Search, TRECVID 2018 (2018).

The accuracy rate of an action label was used as an evaluation index, and evaluation was conducted with 5-fold cross-validation. Table 1 shows comparison results of action recognition accuracy based on whether or not action directions were aligned. In an analogous manner to Reference Document 5, feature extraction by I3D was evaluated for cases where only RGB videos (RGB-I3D) were input, only optical flows (Flow-I3D) were input, and RGB videos and optical flows (Two-stream-I3D) were input.

TABLE 1

| Alignment | Feature | Accuracy |
|---|---|---|
| of action | extraction | rate |
| directions | method | [%] |
| Not aligned | RGB-I3D | 70.0 |
| Not aligned | Flow-I3D | 65.5 |
| Not aligned | Two-Stream-I3D | 69.4 |
| Aligned | RGB-I3D | 77.6 |
| Aligned | Flow-I3D | 79.4 |
| Aligned | Two-Stream-I3D | 83.3 |

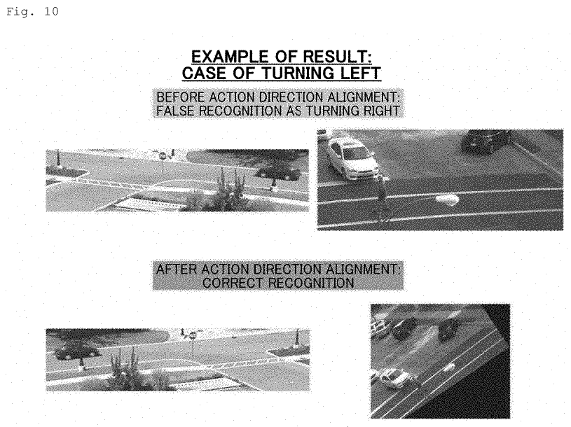

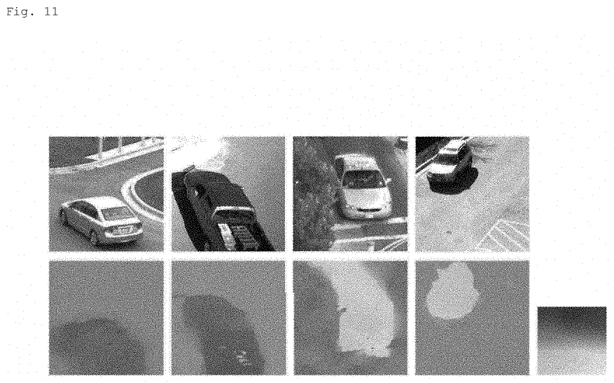

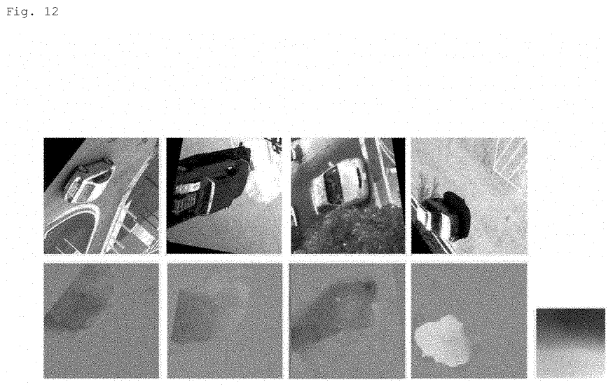

From Table 1, it is clear that the recognition accuracies were improved by aligning the action directions regardless of what were input to I3D. Specifically, when RGB videos and optical flows (Two-stream-I3D) were input, it was confirmed that the accuracy rate was improved by about 14 points by aligning the movement directions (see FIG. 10). In this way, when an optical flow was included in an input, a large improvement in the accuracy was obtained by aligning action directions. The reason is considered to be that an optical flow, which is a movement feature, was more likely to be affected by the diversity of action directions than RGB videos. Also, FIG. 11 shows examples of frame images and visible optical flows before the action directions are aligned. FIG. 12 shows examples of frame images and visible optical flows after the action directions were aligned. In FIGS. 11 and 12, the upper stage shows the frame images and the lower stage shows the optical flows and correspondences between motion vectors and colors. It is clear that the motion vectors of the optical flows (colors in the lower stage) are more similar after the action directions were aligned than before the action directions are aligned. That is to say, it is clear that the action directions of the cars in the videos were aligned with a given direction. Based on the results above, it is clear that aligning action directions contributes an improvement in the accuracy of action recognition.

Note that the present invention is not limited to the above-described embodiments, and various modifications and applications are possible without departing from the spirit of the invention.

For example, the first embodiment has described a case where at least one of rotation and inversion is performed on each frame image so that the action direction of a desired subject is aligned with a reference direction, do that adjusted images are obtained, and the action label of the desired subject is recognized from the adjusted images, but the present invention is not limited to this. For example, a configuration is also possible in which at least one of rotation and inversion is performed so that the action direction of another subject different from the action direction of the desired subject is aligned with the reference direction, so that adjusted images are obtained, and the action label of the desired subject is recognized from the adjusted images.

Also, the second embodiment has described a case where one action direction of the desired subject is calculated from the entire video, at least one of rotation and inversion is performed on all of frame images, so that adjusted images are obtained, and the action label of the desired subject is recognized from the adjusted images, but the present invention is not limited to this. For example, a configuration is also possible in which one action direction of another subject different from the desired subject is calculated from the entire video, at least one of rotation and inversion is performed on all of frame images, so that adjusted images are obtained, and the action label of the desired subject is recognized from the adjusted images.

Also, the second embodiment has described a case where all the frame images are rotated by the same rotation angle, but the present invention is not limited to this, and all the frame images are rotated by substantially the same rotation angle.

The various types of processing that are executed by the CPU reading out and executing software (programs) in the above-described embodiments may be executed by various types of processors other than the CPU. Examples of the processor in this case include a PLD (Programmable Logic Device) capable of changing a circuit configuration after fabrication such as a FPGA (Field-Programmable Gate Array), and a dedicated electrical circuit, which is a processor having a circuit configuration designed exclusively for executing specific processing, such as ASIC (Application Specific Integrated Circuit). Also, the learning processing and action recognition processing may be executed by one of these various types of processors, or by a combination of two or more processors of the same type or different types (such as a plurality of FPGAs, or a combination of a CPU and an FPGA). More specifically, the hardware structures of these various types of processors refer to electrical circuits in which circuit elements such as semiconductor elements are combined with each other.

Also, the above-described embodiments have described an aspect in which a learning processing program and an action recognition program are stored (installed) in advance in the storage 14, but the present invention is not limited to this. The programs may be provided in a form of being stored in a non-transitory storage medium such as a CD-ROM (Compact Disk Read Only Memory), a DVD-ROM (Digital Versatile Disk Read Only Memory), and a USB (Universal Serial Bus) memory. Also, the programs may also be downloaded from an external device via a network.

The following will further disclose additional notes to the above-described embodiments.

(Additional Note 1)

An action recognition device for recognizing, upon input of an image in which a desired subject is captured, an action of the desired subject, including:

a memory; and

at least one processor connected to the memory,

wherein the processor is configured to:

perform at least one of rotation and inversion on the image based on an action direction of the desired subject in the image or an action direction of a subject other than the desired subject, so as to obtain an adjusted image, and

recognize an action of the desired subject using the adjusted image as an input.

(Additional Note 2)

A non-transitory storage medium having stored therein a program that is executable by a computer to execute action recognition processing for recognizing, upon input of an image in which a desired subject is captured, an action of the desired subject,

wherein the action recognition processing is such that at least one of rotation and inversion is performed on the image based on an action direction of the desired subject in the image or an action direction of a subject other than the desired subject, and an adjusted image is obtained, and

an action of the desired subject is recognized using the adjusted image as an input.

### REFERENCE SIGNS LIST

10 Learning device

14 Storage

15 Input unit

16 Display unit

17 Communication interface

19 Bus

20 Object detection unit

22 Optical flow calculation unit

24 Direction alignment unit

26 Action recognition unit

28 Optimization unit

30 Storage device

50 Action recognition device

52 Object detection unit

54 Optical flow calculation unit

56 Direction alignment unit

58 Action recognition unit

1. An action recognition device for recognizing, upon input of an image in which a desired subject is captured, an action of the desired subject, comprising a circuit configured to execute a method comprising:
performing at least one of rotation and inversion on the image based on an action direction of the desired subject in the image or an action direction of a subject other than the desired subject, so as to obtain an adjusted image; and
recognizing an action of the desired subject using the adjusted image as an input.

2. The action recognition device according to claim 1,
wherein the action of the desired subject that is recognized is an action that includes a temporal change in the action direction,
a plurality of the images arranged in a time-series manner are input, and
the circuit further configured to executed a method comprising:
performing at least one of rotation and inversion on an image group that is constituted by the plurality of images, substantially uniformly, so as to obtain adjusted images; and
recognizing the action of the desired subject using the adjusted images that correspond to the plurality of images as inputs.

3. The action recognition device according to claim 1,
wherein the action of the desired subject that is recognized is an action that does not include any temporal change in the action direction,
a plurality of the images arranged in a time-series manner are input, and
the circuit further configured to execute a method comprising:
performing at least one of rotation and inversion on each of the plurality of images, so as to obtain adjusted images; and
recognizing the action of the desired subject using the adjusted images that correspond to the plurality of images as inputs.

4. The action recognition device according to claim 1, the circuit further configured to execute a method comprising:
recognizing the action of the desired subject based on processing obtained by associating second and third images in which the desired subject is captured with each other, the second and third images being subjected to at least one of rotation and inversion so that an action direction of the desired subject in the second image or an action direction of a subject other than the desired subject is equal to an action direction of the desired subject in the third image or an action direction of a subject other than the desired subject.

5. The action recognition device according to claim 1, the circuit further configured to execute a method comprising:
calculating the action direction based on an angle of a motion vector of an optical flow in a region of the image that represents the desired subject; and
performing at least one of rotation and inversion on the image so that the action direction is aligned with a reference direction, thereby obtaining the adjusted image.

6. The action recognition device according to claim 5, the circuit further configured to execute a method comprising:
when a rotation angle required to align the calculated action direction with the reference direction is in a predetermined inversion angle range;
performing inversion on the image; and
performing rotation on the inverted image so that the action direction is aligned with the reference direction, thereby obtaining the adjusted image.

7. A computer-implemented method for recognizing, upon input of an image in which a desired subject is captured, an action of the desired subject, comprising:
performing at least one of rotation and inversion on the image based on an action direction of the desired subject in the image or an action direction of a subject other than the desired subject, so as to obtain an adjusted image; and
recognizing an action of the desired subject using the adjusted image as an input.

8. A computer-readable non-transitory recording medium storing computer-executable program instructions for recognizing, upon input of an image in which a desired subject is captured, an action of the desired subject, the action recognition program instructions that when executed by a processor causes a computer system to execute a method comprising:
performing at least one of rotation and inversion on the image based on an action direction of the desired subject in the image or an action direction of a subject other than the desired subject, so as to obtain an adjusted image; and
recognizing an action of the desired subject using the adjusted image as an input.

9. The action recognition device according to claim 2, the circuit further configured to execute a method comprising:
recognizing the action of the desired subject based on processing obtained by associating second and third images in which the desired subject is captured with each other, the second and third images being subjected to at least one of rotation and inversion so that an action direction of the desired subject in the second image or an action direction of a subject other than the desired subject is equal to an action direction of the desired subject in the third image or an action direction of a subject other than the desired subject.

10. The action recognition device according to claim 2, the circuit further configured to execute a method comprising:
calculating the action direction based on an angle of a motion vector of an optical flow in a region of the image that represents the desired subject; and
performing at least one of rotation and inversion on the image so that the action direction is aligned with a reference direction, thereby obtaining the adjusted image.

11. The action recognition device according to claim 3, the circuit further configured to execute a method comprising:
recognizing the action of the desired subject based on processing obtained by associating second and third images in which the desired subject is captured with each other, the second and third images being subjected to at least one of rotation and inversion so that an action direction of the desired subject in the second image or an action direction of a subject other than the desired subject is equal to an action direction of the desired subject in the third image or an action direction of a subject other than the desired subject.

12. The computer-implemented method according to claim 7,
wherein the action of the desired subject that is recognized is an action that includes a temporal change in the action direction,
a plurality of the images arranged in a time-series manner are input, and
the method further comprising:
performing at least one of rotation and inversion on an image group that is constituted by the plurality of images, substantially uniformly, so as to obtain adjusted images; and
recognizing the action of the desired subject using the adjusted images that correspond to the plurality of images as inputs.

13. The computer-implemented method according to claim 7,
wherein the action of the desired subject that is recognized is an action that does not include any temporal change in the action direction,
a plurality of the images arranged in a time-series manner are input, and
the method further comprising:
performing at least one of rotation and inversion on each of the plurality of images, so as to obtain adjusted images; and
recognizing the action of the desired subject using the adjusted images that correspond to the plurality of images as inputs.

14. The computer-implemented method according to claim 7, the method further comprising:
recognizing the action of the desired subject based on processing obtained by associating second and third images in which the desired subject is captured with each other, the second and third images being subjected to at least one of rotation and inversion so that an action direction of the desired subject in the second image or an action direction of a subject other than the desired subject is equal to an action direction of the desired subject in the third image or an action direction of a subject other than the desired subject.

15. The computer-implemented method according to claim 7, the method further comprising:
calculating the action direction based on an angle of a motion vector of an optical flow in a region of the image that represents the desired subject; and
performing at least one of rotation and inversion on the image so that the action direction is aligned with a reference direction, thereby obtaining the adjusted image.

16. The computer-readable non-transitory recording medium according to claim 8,
wherein the action of the desired subject that is recognized is an action that includes a temporal change in the action direction,
a plurality of the images arranged in a time-series manner are input, and
the computer-executable program instructions when executed further causing the computer system to execute a method further comprising:
performing at least one of rotation and inversion on an image group that is constituted by the plurality of images, substantially uniformly, so as to obtain adjusted images; and
recognizing the action of the desired subject using the adjusted images that correspond to the plurality of images as inputs.

17. The computer-readable non-transitory recording medium according to claim 8,
wherein the action of the desired subject that is recognized is an action that does not include any temporal change in the action direction,
a plurality of the images arranged in a time-series manner are input, and
the computer-executable program instructions when executed further causing the computer system to execute a method further comprising:
performing at least one of rotation and inversion on each of the plurality of images, so as to obtain adjusted images; and
recognizing the action of the desired subject using the adjusted images that correspond to the plurality of images as inputs.

18. The computer-readable non-transitory recording medium according to claim 8, the computer-executable program instructions when executed further causing the computer system to execute a method further comprising:
recognizing the action of the desired subject based on processing obtained by associating second and third images in which the desired subject is captured with each other, the second and third images being subjected to at least one of rotation and inversion so that an action direction of the desired subject in the second image or an action direction of a subject other than the desired subject is equal to an action direction of the desired subject in the third image or an action direction of a subject other than the desired subject.

19. The computer-readable non-transitory recording medium according to claim 8, the computer-executable program instructions when executed further causing the computer system to execute a method further comprising:
calculating the action direction based on an angle of a motion vector of an optical flow in a region of the image that represents the desired subject; and
performing at least one of rotation and inversion on the image so that the action direction is aligned with a reference direction, thereby obtaining the adjusted image.

20. The computer-implemented method according to claim 15, the method further comprising:
when a rotation angle required to align the calculated action direction with the reference direction is in a predetermined inversion angle range:
performing inversion on the image; and
performing rotation on the inverted image so that the action direction is aligned with the reference direction, thereby obtaining the adjusted image.
